(19) United States
(12) Patent Application Publication
(10) Pub. No.: US 2013/0111730 A1
(43) Pub. Date: May 9, 2013

(54) Graphite Crucible for Silicone Crystal Production and Method of Ingot Removal

(71) Applicant: GrafTech International Holdings Inc., Parma, OH (US)

(72) Inventors: Andrew Justin Francis, Cleveland, OH (US); Robert Anderson Reynolds, III, Bay Village, OH (US); Ryan Christopher Elliott, Cleveland, OH (US); Gary Dale Shives, Brunswick, OH (US); Prashanth Subramanian, Lakewood, OH (US); Oliver Kruss, Duisburg (DE)

(73) Assignee: GRAFTECH INTERNATIONAL HOLDINGS INC., Parma, OH (US)

(21) Appl. No.: 13/670,962

(22) Filed: Nov. 7, 2012

Related U.S. Application Data
(60) Provisional application No. 61/556,512, filed on Nov. 7, 2011.

(51) Int. Cl. B66F 9/00; B22D 7/06

(52) U.S. Cl. CPC B66F 9/00; B22D 7/06
USPC 29/428; 249/66.1

(57) ABSTRACT

A graphite crucible for processing silicon includes a bottom wall including a bottom wall interior facing surface. A plurality of side walls extend upwardly from the bottom wall, each side wall including a side wall interior facing surface. A contact point is provided on the side wall to prevent upward movement of the crucible during ingot removal. The side walls have a coefficient of thermal expansion perpendicular to the solidification direction that is less than 95% of the coefficient of thermal expansion of the silicon processed therein. Also, the side walls and the bottom wall have a thru-plane thermal conductivity from about 90 to about 160 W/m·K at room temperature.

This application claims the benefit of U.S. Provisional Application 61/556,512 filed Nov. 7, 2011, entitled Graphite Crucible for Silicon Crystal Production and Method of Ingot Removal, which is hereby incorporated herein in its entirety by reference.

### BACKGROUND

Rising demand for energy and limited fossil fuel reserves are increasingly driving demand for alternative energy sources. One particularly important type of alternative energy is solar power, and specifically, the use of photovoltaic cells to produce electricity.

Most photovoltaic cells are made of crystalline silicon which is manufactured in a variety of methods. One common method is through a directional solidification system (DSS) process wherein silicon feedstock is charged in a quartz crucible and heated until the contents of the crucible are melted. Thermal energy is then drawn from the bottom of the crucible. The melt experiences a temperature gradient and the solidification begins at the bottom. Crystals grow upwardly with grain boundaries forming parallel to the solidification direction. To obtain a directional solidification the solidification heat must flow through the growing layer of solid silicon. Therefore, the temperature at the lower part of the crucible should be decreased in coordination with the increase in solid silicon thickness to maintain a steady growth rate.

When a silicon ingot is produced in a crucible made from graphite crucibles removal may be difficult. To begin the weight of the ingot and crucible may easily be hundreds of pounds. Further complicating the removal, the ingot itself may stick at points in the crucible. Accordingly, there is a need in the art for an improved crucible and method of removing ingot therefrom.

### BRIEF SUMMARY

According to one aspect, a graphite crucible for processing silicon includes a bottom wall including a bottom wall interior facing surface. A plurality of side walls extend upwardly from the bottom wall. Each side wall includes a side wall interior facing surface. The side walls have a coefficient of thermal expansion perpendicular to the solidification direction that is less than 95% of the coefficient of thermal expansion of the silicon processed therein. The side walls and the bottom wall includes a thru-plane thermal conductivity from about 90 to about 160 W/m·K at room temperature. At least one of the side walls include a contact point configured to engage a coupling device to prevent movement of the crucible during removal of a silicon ingot.

According to another aspect, a graphite crucible for processing silicon includes a bottom wall including a bottom wall interior facing surface. A plurality of side walls extend upwardly from the bottom wall. Each side wall includes a side wall interior facing surface. The side walls have a coefficient of thermal expansion perpendicular to the solidification direction that is less than 95% of the coefficient of thermal expansion of the silicon processed therein. The side walls and the bottom wall include a thru-plane thermal conductivity from about 90 to about 160 W/m·K at room temperature. At least one of the side walls includes an exterior facing surface that is curved to enable continuous contact between the side wall and a supporting surface while the crucible is tipped from a vertical configuration to a side-laying configuration.

According to yet another aspect, a method is disclosed for removing a silicon ingot from a graphite crucible. The silicon ingot has a top surface and a cut area which will be removed in a post-processing step. The method includes attaching one or more fasteners to the top surface of the crucible at a location in the cut area and pulling upwardly on the one or more fasteners to thereby remove the silicon ingot from the graphite crucible.

### BRIEF DESCRIPTION OF THE DRAWINGS

FIG. 1 is a side partial schematic view of a crucible positioned in a directional solidification furnace.

FIG. 2 is a top view of a crucible.

FIG. 3 is a side section view of the crucible along lines A-A of FIG. 2.

FIG. 4 is an enlarged section view of the contact point.

FIG. 5 is a side section view of an alternate embodiment of the crucible.

FIG. 6 is a side section view of a further alternate embodiment of the crucible.

FIG. 7 is a side view of a silicon ingot.

FIG. 8 is a top view of a silicon ingot.

### DETAILED DESCRIPTION

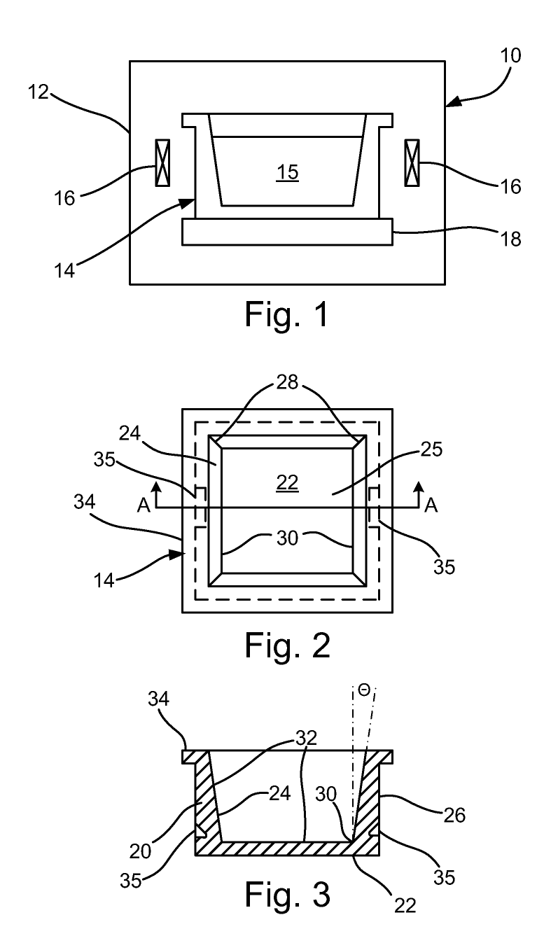

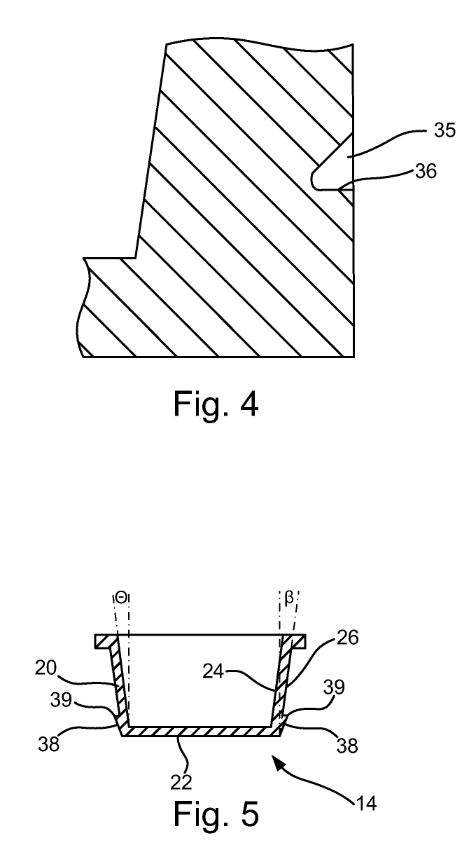

With reference now to FIG. 1, a directional solidification assembly is shown and generally indicated by the numeral 10. The assembly 10 includes a thermally insulated enclosure 12 within which is positioned a crucible 14. One or more heating elements 16 are positioned within enclosure 12 proximate to one or more sides of crucible 14. In the embodiment shown in FIG. 1, two heaters are employed, with one on opposed sides of the crucible 14. However, it should be appreciated that more or fewer heaters may be employed in a variety of locations within enclosure 12. For example, in other embodiments, a heater is positioned next to each side of the crucible 14. In still other embodiments, one or more heaters may be positioned proximate to the crucible top, crucible bottom or both. These top and/or bottom heater(s) may be in conjunction with or in the alternative to side positioned heaters.

Crucible 14 is positioned on, and in thermal contact with a base plate 18. Base plate 18 supports the weight of crucible 14 and also functions as a heat sink to draw thermal energy from the bottom of crucible 14. Base plate 18 may advantageously be a graphite material.

When producing directionally solidified silicon, polysilicon 15 is melted within crucible 14 or is melted and added to crucible 14. Thereafter, heating elements 16 and the heat sink function provided by base plates 18 control the temperature of the silicon 15 charged in crucible 14.

Heating elements 16 are controlled so that thermal energy is drawn from the molten silicon at the bottom of the crucible 14 (through base plate 18). Thus, the solidification process begins at the bottom of the crucible 14 and directionally solidifies to the top of crucible 14. Once the silicon ingot is formed, the silicon is removed from the crucible 14 for further processing. A complete ingot formation cycle is referred to herein as a heat. Each crucible 14 may be used for multiple heats. In one embodiment, the crucible 14 is used for at least 20 heats. More advantageously, the crucible 14 is used for at least 30 heats. Still more advantageously the crucible 14 is used for at least 40 heats.

The crucible 14 may be generally rectangular or square shaped. As shown in FIGS. 2 and 3, crucible 14 includes four side walls 20 and a bottom wall 22. Each of the four side walls 20 includes an inner face 24 and an outer face 26. Because the silicon ingot solidifies within crucible 14, inner faces 24 are disposed at an angle Θ other than perpendicular to bottom wall 22 to enable removal of the silicon ingot. In one embodiment, inner faces 24 are disposed at greater than about 1 degree angle from perpendicular relative to bottom wall 22. In other embodiments, inner faces 24 are disposed at a greater than about 2 degree angle from perpendicular relative to bottom wall 22. In still other embodiments, inner faces 24 are disposed at a greater than about 3 degree angle from perpendicular relative to bottom wall 22. In still further embodiments, inner faces 24 are disposed at a greater than about 4 degree angle from perpendicular relative to bottom wall 22. In these or other embodiments, inner faces 24 are disposed at an angle from about 1 degrees to about 5 degrees. In still further embodiments, inner faces 24 are disposed at an angle from about 2 degrees to about 4 degrees.

A corner 28 is formed between adjacent inner faces 24. Another corner 30 is formed between each inner face 24 and the bottom wall 22. Corners 28 and 30 may include a radius. In one embodiment, the radius is from about 5 mm to about 20 mm. In other embodiments the radius is from about 8 mm to about 15 mm. In still a still further embodiment, the radius is from about 10 mm to about 12 mm.

In one embodiment, crucible 14 has a vertical height of greater than about 350 mm. In other embodiments, crucible 14 has a vertical height of greater than about 400 mm. In still further embodiments, the crucible 14 has a vertical height of greater than about 500 mm. In still further embodiments the crucible has a vertical height greater than about 600 mm. In these or other embodiments, the crucible may have a height between about 400 mm and about 800 mm.

In one embodiment the bottom wall 22 is a quadrilateral having at least one side greater than about 700 mm. In other embodiments the bottom wall has at least one side greater than about 800 mm. In still further embodiments, the bottom wall has at least one side greater than about 1000 mm. In these or other embodiments, the bottom wall 22 is in the form of a square.

In one embodiment, the side walls 20 have a thickness of from about 15 mm to about 50 mm. In other embodiments, the side walls 20 have a thickness from about 20 mm to about 40 mm. In still other embodiments, the side walls 20 have a thickness from about 20 mm to about 25 mm. In one embodiment, the bottom wall 22 has a thickness of from about 15 mm to about 50 mm. In other embodiments, the bottom wall 22 has a thickness from about 20 mm to about 40 mm. In still other embodiments, the bottom wall 22 has a thickness from about 20 mm to about 25 mm.

In one embodiment, the directional solidification assembly 10 may be used in the absence of a base plate 18. In such an embodiment, the bottom wall 22 may have a thickness of from about 25 mm to about 75 mm. In other embodiments, the bottom wall 22 has a thickness from about 35 mm to about 65 mm. In still other embodiments, the bottom wall 22 has a thickness from about 45 mm to about 55 mm. In still further embodiments, the bottom wall has a thickness that is at least about 1.5 times greater than the thickness of the side walls. In still further embodiments, the bottom wall has a thickness that is at least about 2 times the thickness of the side walls.

The crucible 14 advantageously includes a thin layer of coating material 32 on inner faces 24 and the upwardly facing surface 25 of bottom wall 22. Material 32 advantageously has a thickness of from about 50 μm to about 1 mm. More advantageously, material 32 has a thickness of from about 150 μm to about 400 μm. Coating material 32 may function as a release agent, to ease the removal of the silicon ingot from crucible 14 after solidification. Material 32 may further protect the crucible from silicon penetration and the formation of SiC within the interior and exterior of walls 20 and 22 which may lead to premature failure. Coating material 32 is advantageously silicon nitride Si₃N₄. Coating material 32 may be applied by spraying with a fine mist nozzle with a controlled number of spray passes, drying, and sintering in an oven. Alternately, material 32 may be applied by drain casting, whereby the crucible is filled with a silicon nitride slurry for a controlled amount of time resulting in a fine layer of powder coating. The crucible is then emptied and the coating remains on the wall to be dried and sintered. Alternately, the material 32 may be painted on faces 24 and 25 with a brush or roller, then dried and sintered. The coating material 32 is advantageously permanent and will not require reapplication for the life of the crucible 14. However, depending on use conditions, coating material 32 may be reapplied after each heat. In other embodiments, the coating material 32 is reapplied after every other heat. In still other embodiments, the coating material 32 is reapplied after every third heat. In still other embodiments, the coating material 32 is reapplied every fourth heat.

A lip 34 may be provided at the top of side walls 20. Lip 34 provides a laterally extending surface which may be used to capture and/or lift the crucible 14. Though the drawings show a lip 34 extending from each side wall 20, it should be appreciated that, alternately, lip 34 may extend from only two, opposed side walls 20. In other embodiments, the crucible 14 may not include a lip extending from any side walls.

When removing the ingot from the crucible 14, it may be desirable to forceably hold the crucible 14 down while at the same time pulling up on the solidified ingot as will be described later in greater detail. Alternately, it may be desirable to be secured to a turning table that enables rotation of the crucible 14 from a vertical orientation to an upside down orientation (i.e. 180 degrees). Thus, crucible 14 may further advantageously include a capture point in the form of a groove or notched area 35. The capture points are configured to receive a coupling or mounting device that includes a projection sized to engage the notched area 35. In this manner, crucible 14 may be securely held as the ingot is removed.

In the embodiment show, a pair of notched areas 35 are located on opposed side walls 20. Notches areas 35 are advantageously located proximate to the bottom wall 22. However, it should be appreciated that the notched areas 35 may be located at any point on side wall 20. Further, though only two notched areas 35 are shown, it should be appreciated that additional notched areas 35 may be provided, either on the remaining two side walls 20, or by including more than one notched area 35 per side wall. Further, though the notched portion 35 is shown as extending laterally approximately one-fifth the lateral length of the side wall 20, it should be appreciated that the notched portion 35 may be shorter or longer. In one embodiment, the notched portion 35 extends substantially the entire lateral length of the side wall 20. In other embodiments the notched portion 35 extends less than half the lateral length of the side wall 20. In one embodiment, the notched portion 35 extends inwardly to a depth of at least about 5 percent of the thickness of the side wall 20. In other embodiments, the notched portion 35 extends inwardly to a depth of at least about 10 percent of the thickness of the side wall 20. In still further embodiments, the notched portion 35 extends inwardly to a depth of at least about 25 percent of the thickness of the side wall 20.

In the embodiment shown, the notched portion 35 is generally triangular in cross-section, with a bottom wall 36 extending generally parallel to the bottom wall 22. In this fashion, a matching projection from a holding assembly may be inserted into the notched portion 35 and contact the notch bottom wall 36 to prevent or inhibit upward movement of the crucible 14 when an exterior force is applied (i.e. pulling force on the ingot during removal). It should further be appreciated that notched portion 35 may take any shape and must simply be configured to receive a projection from a holding assembly. Further, as will be shown below, the contact point does not have to be in the form of a notch or depression. Instead, it may be in the form of an outwardly extending projection.

With reference now to FIG. 5, an alternate crucible configuration is shown. Crucible 14 of FIG. 5 is substantially similar to crucible 14 of FIGS. 1-3 except for the contact point configuration and that the outer faces 26 of side walls 20 are oriented at an angle β other than perpendicular from bottom wall 22. In one embodiment, outer faces 26 are disposed at greater than about 1 degree angle from perpendicular relative to bottom wall 22. In other embodiments, outer faces 26 are disposed at a greater than about 2 degree angle from perpendicular relative to bottom wall 22. In still other embodiments, outer faces 26 are disposed at a greater than about 3 degree angle from perpendicular relative to bottom wall 22. In still further embodiments, outer faces 26 are disposed at a greater than about 4 degree angle from perpendicular relative to bottom wall 22. In these or other embodiments, outer faces 26 are disposed at an angle from about 1 degrees to about 5 degrees. In still further embodiments, outer faces 26 are disposed at an angle from about 2 degrees to about 4 degrees. In still further embodiments, the inner face 24 and outer face 26 are substantially parallel. In this or other embodiments, the side walls 20 may have a substantially uniform thickness from the bottom to the top of the side wall 20. As can be seen, such a configuration of crucible 14 may allow multiple crucibles 14 to be efficiently machined from an extruded cylindrical stock with reduced waste by using coring machining techniques.

As discussed above, the contact point may alternately take the form of a projection 38 instead of a notched portion. As shown in FIG. 5, projection 38 may be generally triangular in shape having a projection top wall 39 that is generally parallel to crucible bottom wall 22. In this fashion, a projection from a holding assembly may be brought into engagement with projection 38 and contact the projection top wall 39 to prevent or inhibit upward movement of the crucible 14 when an exterior force is applied (i.e. pulling force on the ingot during removal). It should further be appreciated that projection 38 may take any shape and must simply be configured to engage a projection from a holding assembly. Likewise, the size, number and location on the crucible 14 of the projection 38 may be the same as that described hereinabove in reference to the notched portion 35.

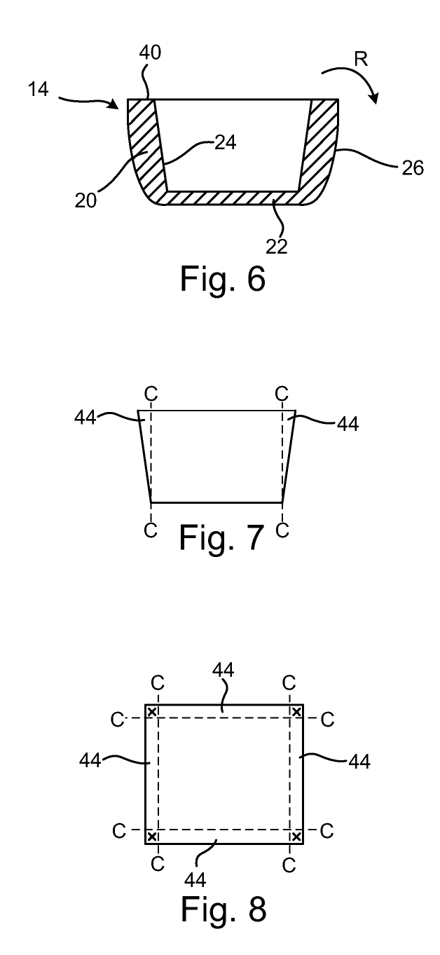

With reference now to FIG. 6, an alternate embodiment of crucible 14 is shown which is substantially similar to the crucible of FIG. 2, except that the outer face 26 of at least one side wall 20 is outwardly curved. In one embodiment, outer face 26 includes a degree of curvature such that the curved side wall maintains continuous contact with the supporting surface while moving from a vertical configuration to a side-laying configuration. In this manner the curvature is sufficient to enable crucible 14 to be tipped over and allow relatively smooth rotation from a vertical configuration to a configuration wherein the crucible 14 is laying on its side. In one embodiment, the curved outer face 26 is substantially parallel to bottom wall 22 at the interface between curved outer face 26 and bottom wall 22. In this or other embodiments, the curved outer face 26 is substantially perpendicular to a top surface 40 of crucible 14. In this or other embodiments, only one side wall 20 includes a curved outer face 26. In other embodiments, such as shown in FIG. 16, two opposed side walls 20 include an curved outer face 26. In still further embodiments all side walls 20 include a curved outer face.

The room-temperature coefficient of thermal expansion (hereinafter “CTE”) of the crucible 14 affects life and ease of silicon removal and is therefore particularly consequential in the direction perpendicular to solidification (i.e. in the plane parallel to the bottom wall). Thus, if extruded stock is the base material, the against-grain CTE is of particular consequence. However, if molded stock is the base material, the with-grain CTE is of particular consequence. In one embodiment, the crucible 14 has a coefficient of thermal expansion perpendicular to the solidification direction that is less than 95% of the CTE of the silicon processed therein (CTE of Si at room temperature is about 3.5×10⁻⁶/° C.). Even more advantageously, the crucible 14 has a CTE in the direction perpendicular to solidification of less than 85% of the CTE of the silicon processed therein. Still more advantageously, the crucible 14 has a CTE in the direction perpendicular to solidification of less than 75% of the silicon processed therein. In these or other embodiments the crucible 14 exhibits a CTE in the direction perpendicular to solidification of from about 1.0×10⁻⁶/° C. to about 3.0×10⁻⁶/° C. In another embodiment, the CTE in the direction perpendicular to solidification is from about 2×10⁻⁶/° C. to about 2.5×10⁻⁶/° C.

Advantageously the crucible 14 has a thru-plane (i.e. parallel to heat flow and solidification) thermal conductivity of from about 80 to about 200 W/m·K at room temperature. In other embodiments, the thermal conductivity is from about 90 to about 160 W/m·K at room temperature. In other embodiments, the thermal conductivity is from about 120 to about 130 W/m·K at room temperature.

Advantageously the crucible 14 has a with-grain compressive strength of from between 15 and 22 MPa. In other embodiments, the with-grain compressive strength is from between about 17 and about 20 MPa. In this or other embodiments, the against-grain compressive strength is advantageously between about 17 and about 24 MPa. In other embodiments, the against-grain compressive strength is from between about 19 and about 21 MPa.

Advantageously the coating material 32 provides a substantially gas impermeable layer that effectively prevents silicon from contacting the graphite material of crucible 14. The coating material advantageously exhibits a gas permeability of less than about 0.01 Darcy. Even more advantageously, the coating material exhibits a gas permeability of less than about 0.005 Darcy. Still more advantageously, the coating material exhibits a gas permeability of less than about 0.002 Darcy. However, the graphite material of crucible 14 also advantageously exhibits a gas permeability of less than about 0.01 Darcy. Even more advantageously, the graphite material of crucible 14 exhibits a gas permeability of less than about 0.005 Darcy. Still more advantageously, the graphite material of crucible 14 exhibits a gas permeability of less than about 0.002 Darcy. The relatively low permeability of the crucible graphite material provides added safety and improved life should a failure or degradation of the coating material occur.

Crucible 14 is preferably a graphite material. The graphite material may be formed by first combining a filler, binder and additional optional ingredients. In one embodiment, the filler is a calcined petroleum coke. The binder may be, for example, a coal tar pitch. Other fillers may include, for example, recycled graphite. In one embodiment the calcined petroleum coke is crushed, sized and mixed with a coal-tar pitch binder and optionally one or more fillers and/or other ingredients to form a blend.

The mix is then formed into an article of green stock by either, extrusion though a die, molding in a conventional forming mold or through isomolding. The mold may form the green stock in substantially final form and size, although some machining of the final article is typically needed.

After extrusion, the green stock is heat treated by baking at a temperature of between about 700° C. and about 1100° C., more preferably between about 800° C. and about 1000° C. to carbonize the pitch binder to solid pitch coke, which gives the article permanency of form. The bake cycle is performed in the substantial absence of air to avoid oxidation at a rate of about 1° C. to about 5° C. rise per hour to the final temperature. After baking, the carbonized stock may be impregnated one or more times with coal tar pitch or petroleum pitch, or other types of pitches or resins known in the industry, to deposit additional coke in any open pores of the stock to reach the desired strength and density. Each impregnation is then followed by an additional baking step.

After baking, the carbonized stock is graphitized. Graphitization is performed by heating the carbonized article to a final temperature of from between about 2500° C. to about 3400° C. for a time sufficient to cause the carbon atoms in the coke and pitch coke binder to transform from a poorly ordered state into the substantially crystalline structure of graphite. Advantageously, graphitization is performed by maintaining the carbonized stock at a temperature of at least about 2700° C., and more advantageously at a temperature of from between about 2700° C. and about 3200° C. At these high temperatures, non-carbon elements are volatilized and escape as vapors. The time required for maintenance at the graphitization temperature is from, for example, about 5 minutes to about 240 minutes. Once graphitization is completed, as discussed above, the graphitized article can be machined to reach the final crucible form disclosed above.

Commonly, silicon ingots are produced in quartz crucibles. After each heat, the silicon ingot is removed by simply destroying the quartz crucible. This method of removal is of course not possible if a graphite crucible is to be used for multiple heats. Accordingly, a plurality of methods of removing the silicon ingot are described herein below.

A first method of removing the silicon ingot incorporates the crucible shown and described in FIG. 6. As can be seen, after the ingot has solidified, the crucible 14 may be tipped in the R direction onto its side, whereby the ingot may be removed more easily. In other embodiments, the crucible 14 may be tipped on its side and then further onto its top surface (i.e. rotating a full 180 degrees). Thereafter the crucible may be lifted upwardly, leaving the ingot behind on the support surface.

With reference now to FIGS. 7 and 8, a silicon ingot 42 removed from the crucible is shown and described. As can be seen, because of the shape of the crucible, each side of the ingot 42 is angled. After removal from the crucible, the ingot 42 is machined into a rectangular or square block. Thus, the angled walls are cut away along lines C-C. Because the material is cut away during the regular processing of the ingot, operations may be performed on this cut area 44 of the ingot 42 without otherwise reducing the yield.

For example, in one embodiment, one or more fasteners may be attached to the ingot 42 at cut area 44. The fasteners may then be attached to cables or a lift system that pulls the crucible 14 upwardly out of crucible 14. This method may be used while also applying downward force to one or more crucible contact points described hereinabove. In this manner, the ingot 42 may be removed from crucible 14, and sufficient force may also be applied to overcome any sticking or friction force between the ingot 42 and crucible 14. In one embodiment, the fastener is mechanically fastened to the ingot 42 by, for example, a threaded screw. In other embodiments, the fastener is adhesively fastened to the ingot 42. In these or other embodiments, the fastener may be positioned at each corner “X” of the ingot 42. However, it should be appreciated that any number of fasteners may be positioned anywhere in the cut area 44.

The various embodiments described herein can be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed:

1. A graphite crucible for processing silicon, the crucible comprising:
a bottom wall including a bottom wall interior facing surface;
a plurality of side walls extending upwardly from said bottom wall, each said side wall including a side wall interior facing surface, said side walls have a coefficient of thermal expansion perpendicular to the solidification direction that is less than 95% of the coefficient of thermal expansion of the silicon processed therein; and wherein said side walls and said bottom wall includes a thru-plane thermal conductivity from about 90 to about 160 W/m·K at room temperature, and;
wherein at least one of said side walls include contact point configured to engage a coupling device to prevent movement of said crucible during removal of a silicon ingot.

2. The graphite crucible according to claim 1 wherein said coefficient of thermal expansion of said side walls is from about 1×10⁻⁶/° C. to about 3×10⁻⁶/° C.

3. The graphite crucible according to claim 1 wherein said coefficient of thermal expansion of said side walls is from about 2×10⁻⁶/° C. to about 2.5×10⁻⁶/° C.

4. The graphite crucible according to claim 1 wherein said thru-plane thermal conductivity of said side walls and said bottom wall is from about 120 to about 130 W/m·K.

5. The graphite crucible according to claim 1 wherein each said side wall interior facing includes a protective coating.

6. The graphite crucible according to claim 1 wherein said protective coating exhibits a gas permeability of less than about 0.01 Darcy.

7. The graphite crucible according to claim 5 wherein said protective coating comprises silicon nitride.

8. The graphite crucible according to claim 1 wherein said contact point comprises a notched portion.

9. The graphite crucible according to claim 1 wherein said contact point comprises a projection.

10. A graphite crucible for processing silicon, the crucible comprising:
a bottom wall including a bottom wall interior facing surface;
a plurality of side walls extending upwardly from said bottom wall, each said side wall including a side wall interior facing surface, said side walls have a coefficient of thermal expansion perpendicular to the solidification direction that is less than 95% of the coefficient of thermal expansion of the silicon processed therein; and wherein said side walls and said bottom wall includes a thru-plane thermal conductivity from about 90 to about 160 W/m·K at room temperature, and;
wherein at least one of said side walls includes an exterior facing surface that is curved to enable continuous contact between said side wall and a supporting surface while the crucible is tipped from a vertical configuration to a side-laying configuration.

11. The graphite crucible of claim 10 wherein said curved exterior facing surface is substantially parallel to bottom wall at the interface between curved exterior facing surface.

12. The graphite crucible of claim 10 wherein said curved exterior facing surface is substantially perpendicular to a top surface of the crucible.

13. The graphite crucible of claim 10 wherein a plurality of said side walls includes a curved exterior facing surface.

14. A method for removing a silicon ingot from a graphite crucible, the silicon ingot having a top surface and a cut area which will be removed in a post-processing step, the method comprising:
attaching one or more fasteners to the top surface at a location in the cut area,
pulling upwardly on said one or more fasteners to thereby remove the silicon ingot from the graphite crucible.

15. The method according to claim 14 further comprising engaging a contact point on a side wall of said crucible with a coupling device to prevent upward movement of said crucible during removal of the silicon ingot.

16. The method according to claim 14 wherein said step of attaching one or more fasteners further comprises mechanically attaching said one or more fasteners with a threaded fastener.
